(19) United States
(12) Patent Application Publication
(10) Pub. No.: US 2004/0175539 A1
(43) Pub. Date: Sep. 9, 2004

(54) Fabric/vinyl placemat and method for fabricating same

(76) Inventor: Andrew Shevins, Woodmere, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/378,322

(22) Filed: Mar. 4, 2003

(51) Int. Cl. B32B 3/06

(52) U.S. Cl. 428/102; 428/192; 156/93

(57) ABSTRACT

The placemat has two sides sewn together along the periphery by spaced stitch lines. One side is cut from a sheet of fabric. The other side is cut from a sheet of vinyl. The edge portions of the sheets are folded and situated between the sides prior to stitching.

The present invention relates to placemats for use on a tabletop or other surface and more particularly to a placemat having one side made of vinyl and a second side made of fabric and to the method of fabricating such a placemat.

Placemats of various shapes and sizes have been known and used for many years to protect the surface of tabletops and the like against damage when a tablecloth or other protector is not used. Such placemats tend to be less expensive than tablecloths, easier to store and easier to clean.

Like tablecloths, placemats are normally formed of a single material, for example, fabric or plastic, such as vinyl. Each of these materials has its advantages. Fabric tends to be more elegant. It is soft to the touch and can be provided in a variety of colors, patterns and textures. However, it can be stained fairly easily, even when treated. Vinyl, on the other hand, is more durable. It is impervious to liquids and hence does not stain easily. Vinyl is often preferred when children or other spill prone individuals are involved.

Placemats are chosen by the type of material from which they were fabricated, depending upon the intended use. Fabric placemats are often purchased for use when aesthetics are important. Vinyl placemats are often bought for practical reasons, when stain resistance and durability are paramount.

Heretofore, there has been no single placemat which fulfills all of these needs simultaneously. In order to have both aesthetics and practicality, two or more sets of placemats are required. My invention overcomes this problem by combining both aesthetics and practicality in a single placemat. This is accomplished by fabricating the placemat out of two different materials, fabric and vinyl, one on each side of the placemat. The sides are sewn together. The resulting placemat has the advantages of a fabric placemat and of a vinyl placemat in a single product.

It is, therefore, a prime object of the present invention to provide a placemat that has the advantages of a placemat made of vinyl and the advantages of a placemat made of fabric.

It is another object to provide a placemat made of fabric and vinyl that has a simple, inexpensive construction.

It is another object of the present invention to provide a method for fabricating a fabric/vinyl placemat.

In accordance with one aspect of the present invention, a placemat is provided for use on a table or the like. The placemat includes a first side and a second side. The first side is formed of a sheet of vinyl. The second side is formed of a sheet of fabric. Means are provided for attaching the first side and the second side proximate the periphery of the placemat.

The attaching means may include a single stitch line or first and second spaced stitch lines.

The vinyl sheet has an edge portion. The edge portion of the vinyl sheet is folded and situated between the sides prior to attaching the sides.

The fabric sheet also has an edge portion. The edge portion of the fabric sheet is folded and situated between the sides prior to attaching the sides.

In accordance with another aspect of the present invention, a method for fabricating a placemat is provided. The method begins by forming a first side from a vinyl sheet with an edge portion. A second side is formed from a fabric sheet with an edge portion. The edge portion of the vinyl sheet is folded. The edge portion of the fabric sheet is folded. The folded portions of the sheets are situated between the sides. The sides are sewn together proximate the periphery of the placemat.

The step of sewing includes forming a first stitch line. In some instances, a second stitch line is formed spaced from the first stitch line.

The method also includes treating the fabric sheet to be stain resistant.

To these and to such other objects which may hereinafter appear, the present invention relates to a fabric/vinyl placement and a method for fabricating same, as set forth in detail in the following specification and recited in the annexed claims, taken together with the accompanying drawings, wherein like numerals refer to like parts and in which:

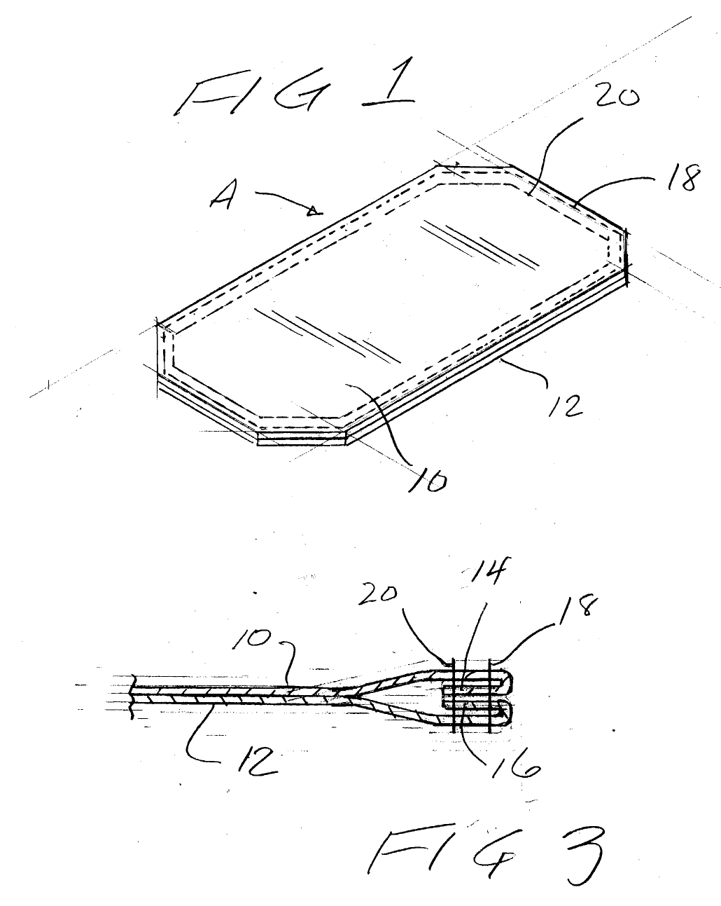

FIG. 1 is an isometric view of the placement of the present invention;

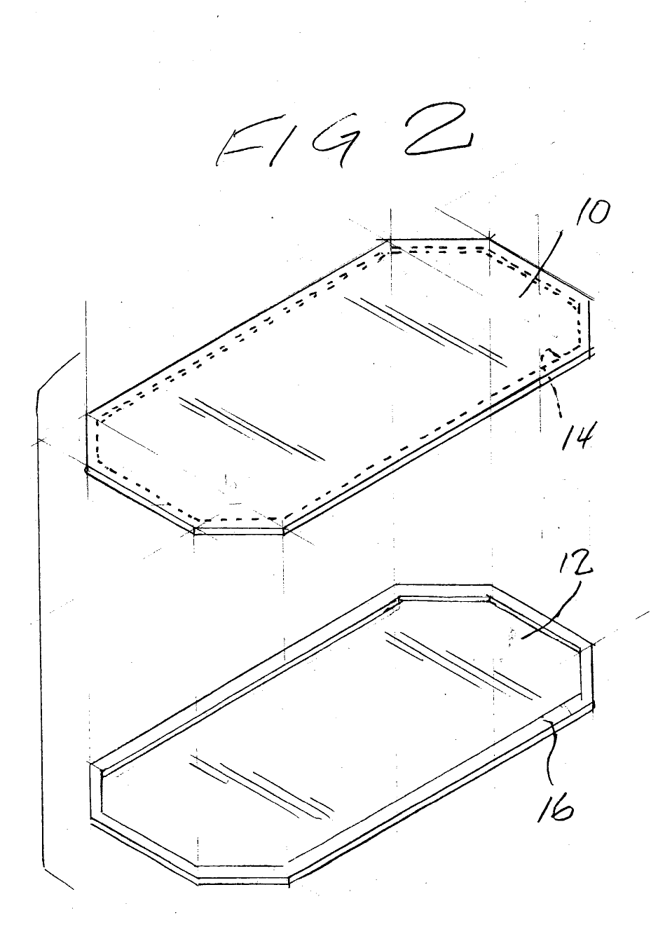

FIG. 2 is an exploded isometric view of the placemat; and

FIG. 3 is a cross-sectional view of the peripheral portion of the placemat.

As seen in FIG. 1, the placemat of the present invention, generally designated A, includes a first side 10 cut to the appropriate size and shape from a sheet of fabric, preferably treated to be stain resistant. The fabric may include any desired pattern or texture for decorative purposes. Placement A also includes a second side 12 cut to the appropriate size and shape from a sheet of vinyl. Each of the sides 10, 12 has an edge portion 14, 16, respectively, that extends beyond what will become the border of the placemat. The sheets can be cut to any size and in any shape, such as rectangular, oval, square or round. The drawings show an eight sided placemat.

As seen in FIG. 3, the edge portions 14, 16 are folded over such that they are situated between sides 10 and 12 prior to stitching the sides together by stitch lines 18, 20. This results in a perfect edge along the entire border of the placemat.

Although spaced stitch lines 18, 20 are preferred, it is possible to assemble the placemat with a single stitch line or even adhesive. In either case, the placemat is fabricated by simple, inexpensive procedures, utilizing conventional equipment. The uniqueness of the placemat rests in the use of different materials for the sides, resulting in greater versatility than any single material placement.

It will now be appreciated that the present invention relates to a fabric/vinyl placement and a method for fabricating same. The placement is extremely versatile, having the aesthetics of a fabric placemat and the practicality of a vinyl placemat. The placement is fabricated in a simple, inexpensive manner, using conventional equipment.

While only a single preferred embodiment of the present invention has been disclosed for purposes of illustration, it is obvious that many variations and modifications could be made thereto. It is intended to cover all of these variations and modifications which fall within the scope of the invention, as defined by the following claims:

I claim:

1. A placemat for use on a table or the like comprising a first side and a second side, said first side being formed from a sheet of vinyl and said second side being formed from a sheet of fabric, and means for attaching said first side and said second side proximate the periphery of the placemat.

2. The placemat of claim 1 wherein said attaching means comprises a stitch line.

3. The placemat of claim 1 wherein said attaching means comprises first and second spaced stitch lines.

4. The placemat of claim 1 wherein said vinyl sheet has an edge portion, said edge portion of said vinyl sheet is folded and situated between said sides.

5. The placemat of claim 1 herein said fabric sheet has an edge portion, said edge portion of said fabric sheet is folded and situated between said sides.

6. The placemat of claim 4 herein said fabric sheet has an edge portion, said edge portion of said fabric sheet is folded and inserted between said sides.

7. A method for fabricating a placemat, the method comprising the steps of.
a. forming a first side from a vinyl sheet with an edge portion;
b. forming a second side from a fabric sheet with an edge portion;
c. folding the edge portion of the vinyl;
d. folding the edge portion of the fabric sheet;
e. situating the folded portions of the vinyl and fabric sheets between the sides; and
f sewing the sides together proximate the periphery of the placemat.

8. The method of claim 7 wherein the step of sewing comprises the steps of forming a first stitch line and forming a second stitch line spaced from the first stitch line.

9. The method of claim 7 further comprising the step of treating the fabric sheet to be stain resistant.
